(19) United States
(12) Patent Application Publication
(10) Pub. No.: US 2025/0056289 A1
(43) Pub. Date: Feb. 13, 2025

(54) METHOD, APPARATUS, AND COMPUTER PROGRAM PRODUCT FOR COLLECTING DATA FROM USER EQUIPMENT DEVICES

(71) Applicant: Nokia Technologies Oy, Espoo (FI)

(72) Inventors: Taylan SAHIN, Munich (DE); Jerediah FEVOLD, Chicago, IL (US); Endrit DOSTI, Espoo (FI); Muhammad Ikram ASHRAF, Espoo (FI)

(73) Assignee: Nokia Technologies Oy, Espoo (FI)

(21) Appl. No.: 18/790,220

(22) Filed: Jul. 31, 2024

Related U.S. Application Data
(60) Provisional application No. 63/518,708, filed on Aug. 10, 2023.

(51) Int. Cl. H04W 24/10; H04L 5/00; H04W 64/00

(52) U.S. Cl. CPC H04W 24/10; H04L 5/0051; H04W 64/00

(57) ABSTRACT

Method, apparatuses, and computer program products provide means for establishing a mechanism through which a network can configure user equipment to determine how to process an indication of region of the user equipment location when establishing a network connection. An example method includes: receiving, from a visited network, a first indication of a region of an apparatus location, where the apparatus includes a User Equipment (UE); and determining, based on a second indication in the apparatus, whether the apparatus shall ignore the first indication for network selection, where the second indication is received from a home network of the apparatus via a container transparent to the visited network. The region of the apparatus location may include a country of the apparatus location. The container may include a Steering of Roaming transparent container. The container may be delivered via a rejection message.

The present application is based on and claims priority to U.S. Provisional Application Ser. No. 63/518,708, filed Aug. 10, 2023, which is incorporated herein by reference in its entirety.

### TECHNOLOGICAL FIELD

An example embodiment of the present disclosure relates generally to collecting data from user equipment devices, and more particularly, to collecting non-standardized data via a network that can be used for training Artificial Intelligence and Machine Learning models.

### BACKGROUND

Mobile devices, such as cellular phones, tablet computers, and the like have evolved to become instrumental tools having a myriad of capabilities to benefit users of the devices. Mobile devices are found everywhere, and have ever-increasing levels of functionality. These mobile devices include sensor suites that are able to gather data relating to the user, movements of the mobile device, and environmental context of the mobile device among other available information. The volume of data collected at mobile devices is extensive, and much of that data can be privacy sensitive.

The data available on mobile devices can be useful for a wide variety of purposes. Further, user-anonymized data can be beneficial in many circumstances, where the mobile device data provides beneficial information to service providers. The data collected on a mobile device can be collected in a wide variety of formats and include different data elements. The type of data and format thereof may differ based on a device manufacturer, an operating system of the mobile device, an application through which certain data was collected, or the like. As such, despite a vast amount of data available from an ever-increasing number of mobile devices, much of this data is of little utility outside of specific applications or use cases.

### BRIEF SUMMARY

Various embodiments generally relate to collecting data from user equipment devices, and more particularly, to collecting non-standardized data via a network that can be used for training Artificial Intelligence and Machine Learning models. Some embodiments provided herein include at least one processor; and at least one memory including computer program code, the at least one memory and computer program code configured to, with the at least one processor, cause the apparatus to: determine a non-standardized data collection policy; receive a non-standardized data request based on the non-standardized data collection policy; determine if the non-standardized data request is compliant with the non-standardized data collection policy; provide the non-standardized data request is compliant with the non-standardized data collection policy; provide the non-standardized data request to a User Equipment (UE) device; receive, from the UE device, data in response to the non-standardized data request; and provide the data in the transparent container to an external server.

According to an embodiment, the non-standardized data request based on the non-standardized data collection policy is received from the external server. The data received from the UE devices is, in an embodiment, received in a transparent container where the data is not decodable by the apparatus.

According to an embodiment, the apparatus is further caused to provide the non-standardized data collection policy to the external server. The non-standardized data collection policy of an embodiment includes an indication of data content that is allowed to be transferred from a UE device to the external server. According to an embodiment, data content that is allowed to be transferred is based on one or more of: a type of data; configuration information, a Radio Access Network (RAN) area, a network coverage area, a g Node B (gNB) service area, a Location Management Function (LMF) service area, or a geographical area of data collection. The non-standardized data request to the UE device is provided in an embodiment in a transparent container. The data of an embodiment includes location data, where the external server employs the location data for Artificial Intelligence/Machine Learning model training.

According to an embodiment, the data content that is allowed to be transferred is further based on one or more of server identifiers or device identifiers. According to an embodiment, the non-standardized data request includes metadata fields describing the data to be collected in response to the non-standardized data request. According to an embodiment, the data in response to the non-standardized data request includes metadata in the metadata fields, where the metadata fields are not in the transparent container. According to an embodiment, the metadata includes one or more of: a type of measurement data, vendor or device information associated with the UE device, a geographical area of data collection, a timestamp of data collection, session information of data collected, quality information of the data collected, a volume of data collected, or a number of data samples collected. According to an embodiment, the non-standardized data collection policy includes an indication of a protocol in which the non-standardized data request should be signaled and a protocol required to carry the data collected in response to the non-standardized data request.

According to an embodiment, the non-standardized data request includes physical layer signal requirements, where the physical layer signaling requirements include standardized configuration information of signals associated with the non-standardized data request. The physical layer signaling requirements can include one or more of downlink positioning reference signal (DL PRS) bandwidth, number of transmission and reception points (TRPs), or Quality of Service (QoS). The apparatus of an embodiment is caused to provide a request to at least one of a Location Management Function (LMF) or g Node B (gNB) to set up required signaling for the non-standardized data request. The apparatus of an embodiment is caused to receive a response from the at least one of the LMF or gNB associated with an actual set up of the LMF or gNB. According to an embodiment, the data in response to the non-standardized data request includes non-standardized data transmitted via a standardized data protocol. The standardized data protocol includes one or more of Long Term Evolution (LTE) Positioning Protocol (LPP) or Radio Resource Control (RRC).

An embodiment provided herein includes a computer program product including at least one non-transitory computer readable storage medium having computer executable program code instructions stored therein, the computer executable program code instructions including program code instruction configured, upon execution, to: determine a non-standardized data collection policy; receive a non-standardized data request based on the non-standardized data collection policy; determine if the non-standardized data request is compliant with the non-standardized data collection policy; provide the non-standardized data request is compliant with the non-standardized data collection policy; provide the non-standardized data request to a User Equipment (UE) device; receive, from the UE device, data in response to the non-standardized data request, where the data is not decodable by a network; and provide the data in the transparent container to the external server.

According to an embodiment, the non-standardized data request based on the non-standardized data collection policy is received from the external server. The data received from the UE device is received in an embodiment, in a transparent container where the data is not visible to a network. According to an embodiment, the computer executable program code instructions further include program code instruction configured to provide the non-standardized data collection policy to the external server. The non-standardized data collection policy of an embodiment includes an indication of data content that is allowed to be transferred from a UE device to the external server. According to an embodiment, data content that is allowed to be transferred is based on one or more of: a type of data; configuration information, a Radio Access Network (RAN) area, a network coverage area, a g Node B (gNB) service area, a Location Management Function (LMF) service area, or a geographical area of data collection. The data content that is allowed to be transferred is, in an embodiment, further based on eon or more of server identifiers or device identifiers. The non-standardized data request to the UE device is provided in an embodiment in a transparent container. The data of an embodiment includes location data, where the external server employs the position-related data for Artificial Intelligence/Machine Learning model training. According to an embodiment, the non-standardized data request includes metadata fields describing the data to be collected in response to the non-standardized data request.

According to an embodiment, the data in response to the non-standardized data request includes metadata in the metadata fields, where the metadata fields are not in the transparent container. According to an embodiment, the metadata includes one or more of: a type of measurement data, vendor or device information associated with the UE device, a geographical area of data collection, a timestamp of data collection, session information of data collected, quality information of the data collected, a volume of data collected, or a number of data samples collected.

According to an embodiment, the non-standardized data request includes physical layer signal requirements, where the physical layer signaling requirements include standardized configuration information of signals associated with the non-standardized data request. The physical layer signaling requirements can include one or more of downlink positioning reference signal (DL PRS) bandwidth, number of transmission and reception points (TRPs), or Quality of Service (QoS). The computer program product of an embodiment includes program code instructions to provide a request to at least one of a Location Management Function (LMF) or g Node B (gNB) to set up required signaling for the non-standardized data request. The computer program product of an embodiment includes program code instructions to receive a response from the at least one of the LMF or gNB associated with an actual set up of the LMF or gNB. According to an embodiment, the data in response to the non-standardized data request includes non-standardized data transmitted via a standardized data protocol. The standardized data protocol includes one or more of Long Term Evolution (LTE) Positioning Protocol (LPP) or Radio Resource Control (RRC).

An embodiment provided herein includes a method including: determining a non-standardized data collection policy; receiving a non-standardized data request based on the non-standardized data collection policy; determining if the non-standardized data request is compliant with the non-standardized data collection policy; providing the non-standardized data request is compliant with the non-standardized data collection policy; providing the non-standardized data request to a User Equipment (UE) device; receiving, from the UE device, data in response to the non-standardized data request; and providing the data in the transparent container to the external server.

According to an embodiment, the non-standardized data request based on the non-standardized data collection policy is received from the external server. The data received from the UE device is received, in an embodiment, in a transparent container where the data is not visible to a network. According to an embodiment, the method includes providing the non-standardized data collection policy to the external server. The non-standardized data collection policy of an embodiment includes an indication of data content that is allowed to be transferred from a UE device to the external server. According to an embodiment, data content that is allowed to be transferred is based on one or more of: a type of data; configuration information, a Radio Access Network (RAN) area, a network coverage area, a g Node B (gNB) service area, a Location Management Function (LMF) service area, or a geographical area of data collection. The non-standardized data request to the UE device is provided in an embodiment in a transparent container. The data of an embodiment includes position-related data, where the external server employs the position-related data for Artificial Intelligence/Machine Learning model training.

According to an embodiment, the non-standardized data request includes metadata fields describing the data to be collected in response to the non-standardized data request. According to an embodiment, the data in response to the non-standardized data request includes metadata in the metadata fields where the metadata fields are not in the transparent container. According to an embodiment, the metadata includes one or more of: a type of measurement data, vendor or device information associated with the UE device, a geographical area of data collection, a timestamp of data collection, session information of data collected, quality information of the data collected, a volume of data collected, or a number of data samples collected.

According to an embodiment, the non-standardized data request includes physical layer signal requirements, where the physical layer signaling requirements include standardized configuration information of signals associated with the non-standardized data request. The physical layer signaling requirements can include one or more of downlink positioning reference signal (DL PRS) bandwidth, number of transmission and reception points (TRPs), or Quality of Service (QoS). The method of an embodiment includes providing a request to at least one of a Location Management Function (LMF) or g Node B (gNB) to set up required signaling for the non-standardized data request. The method of an embodiment includes receiving a response from the at least one of the LMF or gNB associated with an actual set up of the LMF or gNB. According to an embodiment, the data in response to the non-standardized data request includes non-standardized data transmitted via a standardized data protocol. The standardized data protocol includes one or more of Long Term Evolution (LTE) Positioning Protocol (LPP) or Radio Resource Control (RRC).

An embodiment provided herein includes an apparatus including: means for determining a non-standardized data collection policy; means for receiving a non-standardized data request based on the non-standardized data collection policy; means for determining if the non-standardized data request is compliant with the non-standardized data collection policy; means for providing the non-standardized data request is compliant with the non-standardized data collection policy; means for providing the non-standardized data request to a User Equipment (UE) device; means for receiving, from the UE device, data in response to the non-standardized data request; and means for providing the data in the transparent container to an external server.

According to an embodiment, the non-standardized data request based on the non-standardized data collection policy is received from the external server. The data received from the UE device is received, in some embodiments, in a transparent container where the data is not visible to a network. According to an embodiment, the apparatus includes means for providing the non-standardized data collection policy to the external server. The non-standardized data collection policy of an embodiment includes an indication of data content that is allowed to be transferred from a UE device to the external server. According to an embodiment, data content that is allowed to be transferred is based on one or more of: a type of data; configuration information, a Radio Access Network (RAN) area, a network coverage area, a g Node B (gNB) service area, a Location Management Function (LMF) service area, and or a geographical area of data collection. The data content that is allowed to be transferred is, in an embodiment, further based on one or more of server identifiers or device identifiers. The non-standardized data request to the UE device is provided in an embodiment in a transparent container. The data of an embodiment includes position-related data, where the external server employs the position-related data for Artificial Intelligence/Machine Learning model training.

According to an embodiment, the non-standardized data request includes metadata fields describing the data to be collected in response to the non-standardized data request. According to an embodiment, the data in response to the non-standardized data request includes metadata in the metadata fields, where the metadata fields are not in the transparent container. According to an embodiment, the metadata includes one or more of: a type of measurement data, vendor or device information associated with the UE device, a geographical area of data collection, a timestamp of data collection, session information of data collected, quality information of the data collected, a volume of data collected, or a number of data samples collected.

According to an embodiment, the non-standardized data request includes physical layer signal requirements, where the physical layer signaling requirements include standardized configuration information of signals associated with the non-standardized data request. The physical layer signaling requirements can include one or more of downlink positioning reference signal (DL PRS) bandwidth, number of transmission and reception points (TRPs), or Quality of Service (QoS). The apparatus of an embodiment includes means for provides a request to at least one of a Location Management Function (LMF) or g Node B (gNB) to set up required signaling for the non-standardized data request. The apparatus of an embodiment includes means for receiving a response from the at least one of the LMF or gNB associated with an actual set up of the LMF or gNB. According to an embodiment, the data in response to the non-standardized data request includes non-standardized data transmitted via a standardized data protocol. The standardized data protocol includes one or more of Long Term Evolution (LTE) Positioning Protocol (LPP) or Radio Resource Control (RRC).

An embodiment provided herein includes at least one processor and at least one memory including computer program code, the at least one memory and the computer program code configured to, with the at least one processor, cause the apparatus to: receive a non-standardized data request with a non-standardized data collection policy; collect measurements and non-standardized data according to the non-standardized data collection policy; and transfer the non-standardized data in a transparent container together with metadata according to the non-standardized data collection policy. The apparatus of an embodiment is further configured to request physical layer signaling requirements, where the physical layer signaling requirements include standardized configuration information of signals associated with the non-standardized data request. The physical layer signaling requirements include, in an embodiment, one or more of downlink positioning reference signal (DL PRS) bandwidth, number of transmission and reception points (TRPs), or Quality of Service (QoS). The apparatus of an embodiment is further caused to request approval to transfer the non-standardized data with metadata fields prior to transmitting the non-standardized data in the transparent container together with metadata.

An embodiment provided herein includes a computer program product having at least one non-transitory computer readable storage medium having computer executable program code instructions stored therein. The computer-executable program code instructions configured, upon execution, to: receive a non-standardized data request with a non-standardized data collection policy; collect measurements and non-standardized data according to the non-standardized data collection policy; and transfer the non-standardized data in a transparent container together with metadata according to the non-standardized data collection policy. The computer program product of an embodiment further includes program code instructions to request physical layer signaling requirements, where the physical layer signaling requirements include standardized configuration information of signals associated with the non-standardized data request. The physical layer signaling requirements include, in an embodiment, one or more of downlink positioning reference signal (DL PRS) bandwidth, number of transmission and reception points (TRPs), or Quality of Service (QoS). The computer program product of an embodiment further includes program code instructions to request approval to transfer the non-standardized data with metadata fields prior to transmitting the non-standardized data in a transparent container together with the metadata.

An embodiment provided herein includes a method including: receiving a non-standardized data request with a non-standardized data collection policy; collecting measurements and non-standardized data according to the non-standardized data collection policy; and transferring non-standardized data in a transparent container together with metadata according to the non-standardized data collection policy. The method of an embodiment further includes requesting physical layer signaling requirements, where the physical layer signaling requirements include standardized configuration information of signals associated with the non-standardized data request. The physical layer signaling requirements include, in an embodiment, one or more of downlink positioning reference signal (DL PRS) bandwidth, number of transmission and reception points (TRPs), or Quality of Service (QoS). The method of an embodiment further includes requesting approval to transfer the non-standardized data with metadata fields prior to transmitting the non-standardized data in the transparent container together with the metadata.

An embodiment provided herein includes an apparatus including: means for receiving a non-standardized data request with a non-standardized data collection policy; means for collecting measurements and non-standardized data according to the non-standardized data collection policy; and means for transferring non-standardized data in a transparent container together with metadata according to the non-standardized data collection policy. The apparatus of an embodiment further includes means for requesting physical layer signaling requirements, where the physical layer signaling requirements include standardized configuration information of signals associated with the non-standardized data request. The physical layer signaling requirements include, in an embodiment, one or more of downlink positioning reference signal (DL PRS) bandwidth, number of transmission and reception points (TRPs), or Quality of Service (QoS). The apparatus of an embodiment further includes means for requesting approval to transfer the non-standardized data with metadata fields prior to transmitting the non-standardized data in the transparent container together with the metadata.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings, which are not necessarily drawn to scale. The components illustrated in the accompanying drawings may or may not be present in certain embodiments described herein. Some embodiments may include fewer (or more) components than those shown in the drawings.

FIG. 1 illustrates an overview of an example mobile network (e.g., 5GS), in accordance with an example embodiment of the present disclosure;

FIG. 2 provides a block diagram of an example apparatus according to an example embodiment of the present disclosure;

FIG. 3 is a signal flow diagram of a method for collecting non-standardized data according to an example embodiment of the present disclosure;

FIG. 4 is a continuation of the signal flow diagram of FIG. 3 of a method for collecting non-standardized data according to an example embodiment of the present disclosure;

FIG. 5 is a signal flow diagram of another method for collecting non-standardized data according to an example embodiment of the present disclosure; and

FIG. 6 is a flowchart of a method for collecting non-standardized data according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” “electronic information,” “signal,” “command,” and similar terms may be used interchangeably to refer to data capable of being captured, transmitted, received, and/or stored in accordance with various embodiments of the present disclosure. Thus, use of any such terms should not be taken to limit the spirit and scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, repeaters, and/or the like, sometimes referred to herein as a “network.” Similarly, where a first computing device is described herein as sending data to a second computing device, it will be appreciated that the data may be sent or transmitted directly to the second computing device or may be sent or transmitted indirectly via one or more intermediary computing devices, such as, for example, one or more servers, remote servers, cloud-based servers (e.g., cloud utilities), relays, routers, network access points, base stations, hosts, repeaters, and/or the like.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

Mobile devices are highly capable computers that employ sensor arrays that generate copious amounts of data. Much of this data is collected for specific use-cases within applications or by service providers for specific purposes. However, the data collected at a mobile device can have wide applicability to a variety of services and service providers. These mobile devices, together with other types of computing devices, are referred to herein as User Equipment (UE). Further, with the advances in Artificial Intelligence (AI) and Machine Learning (ML) models, the collection of training data is beneficial to improving these models and rendering them more accurate and useful. Embodiments described herein endeavor to leverage the copious amounts of data available on mobile devices to provide the large volumes of training data that would benefit AI/ML models while preserving privacy of the users of the mobile devices.

To train AI/ML models, an entity, such as an external vendor server (e.g., mobile device manufacturer, mobile device service carrier, mobile device chip manufacturer, etc.) needs to collect data from a network. Depending upon the AI/ML model, different types of data may be sought. One such type relates to uplink (UL)/downlink (DL) positioning-related measurements and/or UE location information. Most positioning-related data has been standardized within the Location Services (LCS)/LTE Positioning Protocol (LPP) framework. For example, time-based or angle-based measurements as well as User Equipment (UE) location information (e.g., one or more of absolute location coordinates, measurements, general position information, etc.) are well-defined within respective fields in LPP messages.

While standardized data is relatively straight forward to process, it may not be possible to specify/standardize all data that are required for AI/ML models. For example, since each vendor may develop and deploy arbitrarily different models, the vendor may not disclose the model input. A UE vendor may want to train their model outside of 3GPP (3^{rd} Generation Partnership Project) standardized methods considering non-standardized auxiliary inputs, such as Signal to Noise Ratio (SNR), Doppler, sensor measurements, etc. For example, a UE may use Doppler measurements as model input, which is not specified in LPP. Similarly, UEs may be able to use non-configured measurements, where a UE may passively monitor any ongoing DL PRS (Positioning Reference Signal) transmission with which it is not configured, by internal implementation which will be used as model input to a UE-side AI/ML model.

Collecting non-standardized data, such as for training as well as monitoring, retraining, and updating UE-side AI/ML models, is of particular interest to UE vendors. A UE vendor may develop AI/ML models for use at a UE considering different UE categories, power, and computational capabilities of the UE and may not disclose such details of their AI/ML model for positioning purposes deployed at the UE, which could be part of a proprietary algorithm. According to some embodiments, it may not be practical or even possible to standardize each granularity desired by different vendors (e.g. 1 dB step RSRP (Reference Signal Received Power), 0.25 dB step, etc.) to the point which requires inefficient signaling, such as floating point, to cover all of the different possible cases. Further, according to some embodiments, it is not feasible to add new datatypes for non-standardized data collection as the delay between defining the requirements, generating agreements in RAN2 (Radio Layer 2), and then waiting for RAN (Radio Access Network) plenary to integrate the changes into the specification. Such a process could take more than six months, not including implementation and deployment time which can double or triple this time period.

Currently, there is no framework for the UE vendor server to collect non-standardized positioning-related data from a 3GPP network. Specifically, for UE-sided AI/ML model offline training, the existing positioning framework is not suitable for data collection. Therefore, further enhancements are needed. An example embodiment described herein controls flow of data going to external parties through the network where the data transmitted does not require standardization.

An example embodiment described herein harvests data from UE devices for AI/ML training data used by vendor servers to generate, build, and train AI/ML models for use at the UE. An embodiment employs a framework for the network to enable control and management of collecting non-standardized data by vendor servers external to the UE (e.g., OTT (Over the Top) server) which use this data to train, as well as monitor, retrain, and update, UE-side models.

According to an example embodiment, a network may define conditions in the form of a non-standardized data collection policy on what can be reported, and how, by the UE to the vendor servers external to the UE. For example, a network may define a policy as “X type of measurements from a certain area/region of interest/cell/time can be shared with server of vendor Y.” After acquiring such a policy, the external vendor server can send a request for non-standardized data collection to the network based on this policy. The request can include, for example: a) Metadata field; b) transparent container (e.g., a data container that conveys data transparent or not visible to the network); and c) physical layer (PHY) signaling requirements, which may be optional.

The metadata field can indicate any standardized information associated with the non-standardized data collection request, so as to enable the network control over the data collection as much as possible, such as a type of requested data (e.g., DL PRS measurements), vendor information of the UE/server, area/time-related information of the requested data, size of the requested data, etc. The transparent container contains the actual UE-vendor/implementation-specific requirements/request of the non-standardized data collection, which is visible only to the UE, and not visible to the network (e.g., a non-standardized Doppler measurement request). The PHY signaling requirements indicate standardized configuration information of signals associated with the requested data collection, such as DL PRS bandwidth, number of TRPs (Transmission and Reception Points), etc. that would be necessary to collect non-standardized data, which the network can set up to assist collection of the non-standardized data. The PHY signaling requirements is an optional element and the network may not be obliged to set up such required signaling configurations in the network for data collection.

The network can trigger any relevant data collection entities (e.g., LMF for positioning) based on the request from the external vendor server, and let the UE know about the content of the actual request, such as by forwarding the transparent container, and optionally configures any necessary PHY signaling (e.g., transmission of DL PRS by gNBs to enable non-standardized data collection). The inclusion of data collection entities such as the LMF are not required to be involved, and may only be involved in specific use cases that require and/or benefit from such involvement. In the case of the LMF, involvement is based on a positioning use case and is merely an example of a relevant data collection entity. In other embodiments, such as for CSI or beam management use cases, the managing entity may trigger one or more gNB to request necessary signaling. The UE, after collecting the requested non-standardized data, provides the collected data via transparent container back to the external server via network, accompanied by metadata complying with the data collection policy. An example embodiment provided herein enables the network to gain control over the collection and transfer of non-standardized data without necessarily requiring access to the actual content of the collected data.

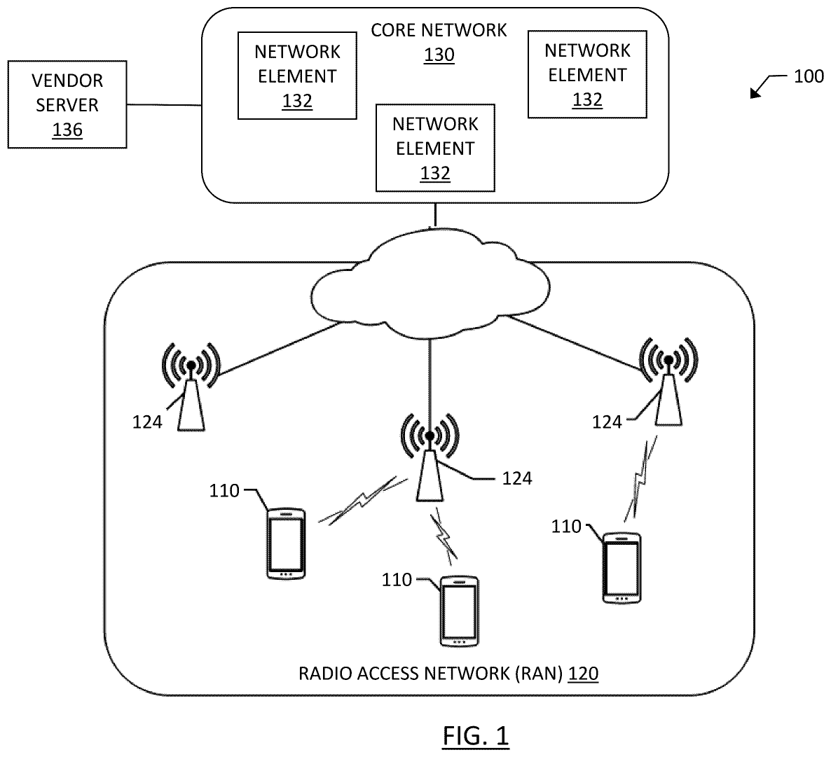

An example embodiment described herein can be implemented over a network. Referring now to FIG. 1, an example mobile network 100 is illustrated. Mobile network 100 (also referred to as a cellular network) is a type of network where at least the last link is wireless, and provides voice and/or data services to a plurality of devices. Mobile network 100 may be a Third Generation (3G), a Fourth Generation (4G), and/or a next generation (e.g., Fifth Generation, or 5G) network.

Mobile network 100 is illustrated as providing communication services to UEs 110. UEs 110 may be enabled for voice services, data services, Machine-to-Machine (M2M) or Machine Type Communications (MTC) services, Internet of Things (IoT) services, and/or other services. A UE 110 may be an end user device such as a mobile phone (e.g., smartphone), a tablet or PDA, a computer with a mobile broadband adapter, and/or the like.

Mobile network 100 includes one or more radio access networks (RAN 120) that communicate with UEs 110 over a radio interface. RAN 120 of one example embodiment may support 5G, Wireless Local Area Network (WLAN) access, fixed access, satellite radio access, new Radio Access Technologies (RAT), and/or the like. As an example, RAN 120 may be embodied by one or more base stations 124 that are dispersed over a geographic area. A base station 124 may comprise an entity that uses radio communication technology to communicate with a UE on the licensed spectrum, and interface the UE with a core network 130. Base stations 124 in a NG-RAN may be referred to as gNodeBs (NR base stations) and/or ng-eNodeBs (LTE base stations supporting a 5G Core Network). As another example, RAN 120 may comprise a WLAN that includes one or more Wireless Access Points (WAP). A WLAN is a network in which a UE is able to connect to a Local Area Network (LAN) through a wireless (radio) connection. A WAP is a node that uses radio communication technology to communicate with a UE over the unlicensed spectrum and provides the UE access to a core network. One example of a WAP is a Wi-Fi access point that operates on the 2.4 GHz or 5 GHz radio bands. The term “base station” then may refer to an eNodeB, a gNodeB, an ng-eNodeB, a WAP, and/or the like.

UEs 110 are able to attach to a cell of a RAN 120 to access a core network 130. RAN 120 therefore represents the radio interface between UEs 110 and core network 130. Core network 130 is the central part of mobile network 100 that provides various services to customers who are connected by RAN 120. One example of core network 130 is the Evolved Packet Core (EPC) network as described by the 3GPP for LTE. Another example of core network 130 is a 5G Core (5GC) network as described by the 3GPP. Core network 130 includes network elements 132, which may comprise servers, devices, apparatuses, or equipment (including hardware) that provide services for UEs 110. Network elements 132, in an EPC network, may comprise a Mobility Management Entity (MME), a Service Gateway (S-GW), a Packet Data Network Gateway (P-GW), and/or the like. Network elements 132, in a 5G network, may comprise an Access and Mobility Management Function (AMF), a Location Management Function (LMF), a Session Management Function (SMF), a User Plane Function (UPF), a Policy Control Function (PCF), a Unified Data Management (UDM), and/or the like.

The Core Network 130 may be in communication with a third party entity, such as Vendor Server 136 which may include a service provider server (e.g., a cellular carrier server), a device manufacturer server, a component (e.g., microchip) manufacturer server, or the like. The Vendor Server may provide one or more services for UEs, and according to certain example embodiments described herein, trains, builds, and improves upon AI/ML models relating to services provided by the Vendor Server. To do so, the Vendor Server may collect data from the UEs over the network as described herein.

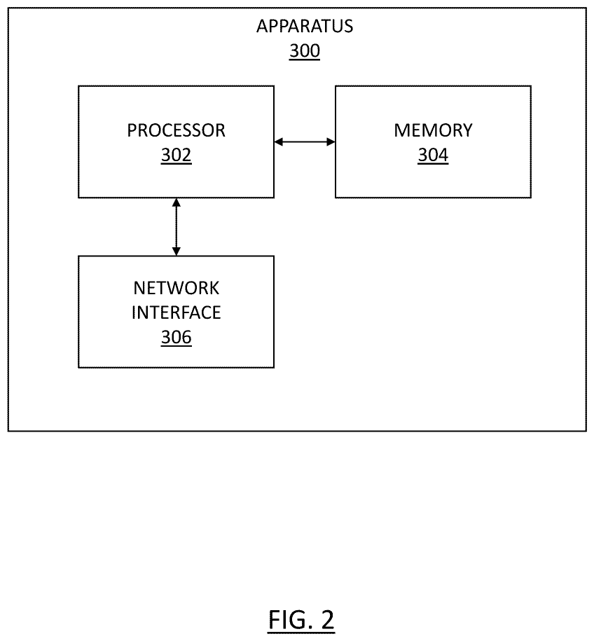

Referring now to FIG. 2, an example apparatus 300 is provided. The apparatus 300 may be an embodiment of a UE 110 and/or may be embodied by or otherwise associated with a UE 110, in some instances. Alternatively, the apparatus 300 may be an embodiment of a network element 132 or may be embodied by or otherwise associated with a network element 132.

The apparatus 300 may include processor 302, memory 304, and network interface 306. The apparatus 300 may be configured to execute the operations described herein. Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may be configured to store information, data, content, applications, instructions, or the like for enabling the apparatus to carry out various functions in accordance with an example embodiment disclosed herein.

The processor 302 may be embodied in a number of different ways and may, for example, include one or more processing devices configured to perform independently. In some non-limiting embodiments, the processor 302 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 302 may be configured to execute instructions stored in the memory 304 and/or circuitry otherwise accessible to the processor 302. In some embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment disclosed herein while configured accordingly. Alternatively, as another example, when the processor 302 is embodied as an executor of software instructions, the instructions may specifically configure the processor 302 to perform the algorithms and/or operations described herein when the instructions are executed.

In some embodiments, the apparatus 300 may include input/output circuitry that may, in turn, be in communication with processor 302 to provide output to a user and/or other entity and, in some embodiments, to receive an indication of an input. The input/output circuitry may comprise a user interface and may include a display, and may comprise a web user interface, a mobile application, a query-initiating computing device, or the like. The processor and/or user interface circuitry comprising the processor may be configured to control one or more functions of one or more user interface elements through computer program instructions (e.g., software and/or firmware) stored on a memory accessible to the processor (e.g., memory 304, and/or the like).

The network interface 306 may be any means such as a device or circuitry embodied in either hardware or a combination of hardware and software that is configured to receive and/or transmit data from/to a network and/or any other device, circuitry, or module in communication with the apparatus 300. In this regard, the network interface 306 may include, for example, a network interface for enabling communications with a wired or wireless communication network. For example, the network interface 306 may include one or more network interface cards, antennae, buses, switches, routers, modems, and supporting hardware and/or software, or any other device suitable for enabling communications via a network. Additionally, or alternatively, the network interface 306 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

An embodiment described herein provides for the collection of non-standardized data according to a predetermined policy that enables the efficient and accurate generate a corpus of training data for use with AI/ML models. A managing entity within the network can manage the process of an example embodiment. This entity could be a core network (CN) entity or function, such as for the positioning AI/ML use case it could be the LMF and/or NWDAF (Network Data Analytics Function). In other AI/ML use cases, the managing entity could include a RAN node, such as a gNodeB. The managing entity can optionally include a Trace Collection Entity (TCE), which may be used, for example, for Minimization of Drive Test (MDT). The managing entity could optionally be, or be part of the OAM (Operations, Administration, and Management), such as having control over a CN and/or RAN.

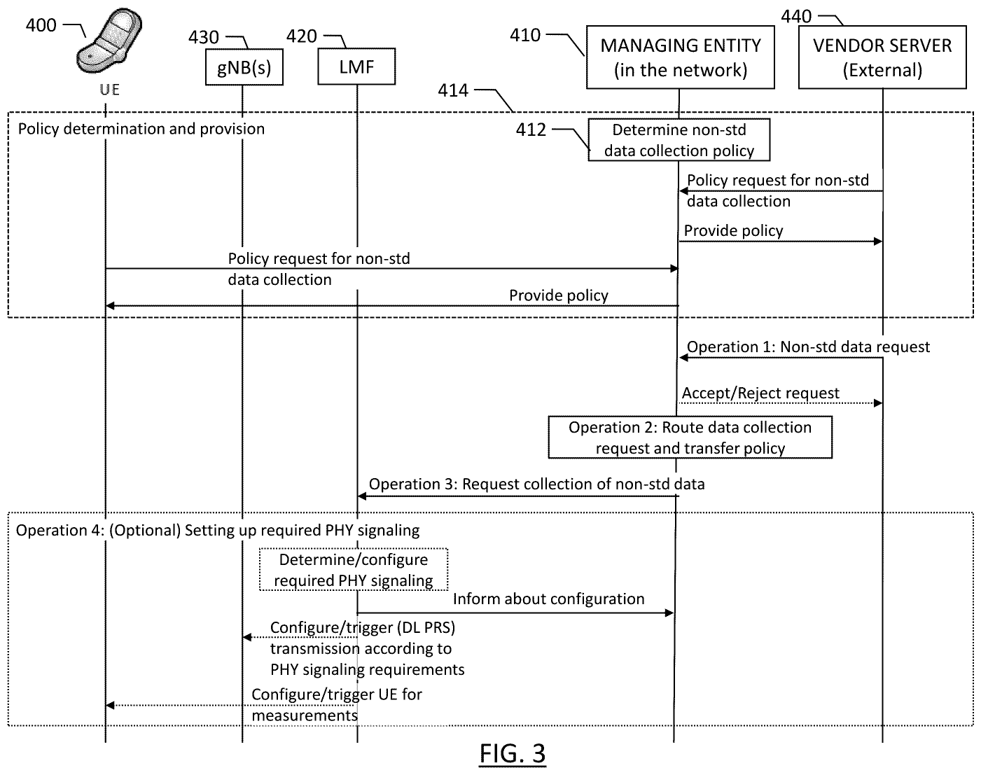

According to the illustrated embodiment of FIG. 3, the Managing Entity 410 is a separate entity from the LMF 420 or gNB 430. Optionally, a single/centralized managing entity/network function for data collection could be responsible for all AI/ML related use cases, which may then communicate with respective entities for each use case, such as the LMF 420 for positioning. The managing entity determines the policy on non-standardized data collection as shown at 412. The policy can be shared with external parties and/or the UE 400.

The policy can include a variety of information, such as one or more of allowed/disallowed data content that can be transferred (e.g., from the UE to the external server), the metadata fields that the UE needs to indicate when transferring data, and/or whether a certain protocol needs to be used when transferring the data. The allowed/disallowed data content that can be transferred can be defined with respect to a type of data (e.g., positioning measurements, CSI measurements, DL PRS measurements, time/angle/power/phase-based measurements, GNSS data, Bluetooth™ data, sensor data, etc.). The permissible data content can be with respect to entities/resources involved in creation of data (e.g., whether gNBs are used to transmit a signal, their identifiers, etc.) or information associated with measurements (e.g., allowed configuration information, etc.). Allowed/disallowed (permissible) data can be with an area (e.g., a notification area, a geographic area, a serving area, etc.) that the collected data or UE/gNB belongs. The allowed/disallowed data can further be with respect to vendor/device (e.g., manufacturer, hardware, software information) of involved UEs or gNBs. In some instances there may be privacy agreements (e.g., GDPR or General Data Protection Regulation) with different vendors to collect or share the data from the network, which may be used to determine the policy.

The metadata fields that a UE needs to indicate when transferring data can include a type of data measurement, vendor/device information of the UE, area/timestamp info of data, any session information data belongs to (e.g., certain LPP (LTE Positioning Protocol) session for positioning), or characteristics of data (e.g., quality, likelihood, confidence level of estimation per sample, per dataset, etc.). The policy information pertaining to whether a certain protocol (e.g., LPP, RRC (Radio Resource Control), NRPPa (NR Positioning Protocol A), UAI (User Assistance Information), etc.) needs to be used when transferring data. Such as when transferring position-related measurements or more generally, the non-standardized data, the UE may be required to send it through LMF via LPP, or alternatively, through LMF with RRC+NRPPa protocols via gNB. An embodiment can include, for CSI or beam management use cases, a UE sending non-standardized data first to gNB via a standardized protocol (e.g., RRC or Medium Access Control Control Element (MAC CE)), which is then sent by the gNB to the managing entity.

The policy is implementation-specific and may be configured by the OAM or the network vendor as appropriate. As part of the configuration, any identifiers of external servers, such as their IP addresses, can be registered so as to control the data transferred to the external servers. The managing entity provides this policy to the external server/vendor and/or UE, unsolicited or upon request (from the external server and/or UE), as well as providing notifications regarding any updates with respect to the policy.

According to an embodiment described herein, the LMF is the managing entity and can provide such policy information to UEs via LPP assistance data or using NRPPa+RRC messages via gNB. The message can be broadcast, groupcast, or unicast. Similarly, the communication between the LMF and gNB can take place using the NRPPa protocol. According to an embodiment, the order of the policy determination in terms of allowed/disallowed content and dissemination of the policy can be different than the illustrated embodiments described below. For example, first a request for a policy may be received from a UE, where the managing entity then determines the policy which it can then furnish to the vendor server.

FIG. 3 illustrates policy determination and provision at 414. In the illustrated embodiment, the policy is determined at 412 for the non-standardized data collection policy. A vendor server 440 sends a request for the policy to the managing entity 410. The managing entity 410 then provides the policy to the vendor server 440. The UE 400 provides a request for the non-standardized data collection policy to the managing entity 410, and the managing entity provides the policy to the UE in return. Regardless of the order of operations of the policy determination and provision, the policy determination ensures all entities are aware of the policy for non-standardized data collection.

The embodiment of FIG. 3, at Operation 1, illustrates a non-standardized data request from the vendor server 440 to the managing entity 410. The request for data collection includes data content that correspond to the previously determined policy. This request includes metadata, a transparent container, and optionally, physical layer signaling requirements.

The metadata field indicates any standardized information associated with the non-standardized data collection request to enable the network control over the data collection as much as possible. The metadata can include an identification of the UE(s) that are requested for data collection, such as the IMEI-TAC (International Mobile Equipment Identity-Type Allocation Code). The metadata can optionally include a type of requested data, such as DL PRS measurements, DL measurements, TRP measurements, time/angle/power/phase-based measurements, etc. The metadata can further include vendor/device information, such as manufacturer, hardware, software information, etc. of the entities involved in the requested data as well as that of the requesting entity. The metadata can include area information such as a notification area, geographical area, serving cell, etc. of the requested data. Time related information of the requested data, such as the date, time frame, periodicity, on-demand/event-triggered information can be included in the metadata. Metadata can further include a size of the requested data, such as a number of measurements/samples, data volume, etc. Other metadata can be included in the request as needed.

The transparent container is a data container that is transparent to the network, as in the network does not see the container or the contents of the container. The transparent container of an embodiment includes the actual UE-vendor/implementation-specific requirements/request for the non-standardized data collection, which is only visible to the UE, and not necessarily to the network. An example includes a non-standardized Doppler measurement request.

The optional physical layer (PHY) signaling requirements indicate standardized configuration information of signals associated with the requested data collection, such as DL PRS bandwidth, number of TRPs, etc. that would be necessary to collect non-standardized data, which the network can setup to assist collection of the non-standardized data. In an example embodiment, QoS (Quality of Service) requirements for the related use case, such as positioning accuracy, could be indicated, which could be further associated with or sent alternatively to PHY signaling requirements. The physical layer signaling requirements are optional and the network may not be obliged to set up such required signaling configurations in the network for data collection. The managing entity 410 can accept or reject the request. The request can be rejected if, for example, it does not comply with the non-standardized data collection policy.

While Operation 1 of FIG. 3 illustrates a non-standardized data request sent from the vendor server 440 to the managing entity 410, the request from the sever may be forwarded via the UE 400, such that the server first sends the request to the UE, which is transparent to the network managing entity 410. The UE 400 can then disclose the request to the network by sending it to the managing entity 410. In another embodiment, the request is sent to the UE 400 from the vendor server 440, via the managing entity 410.

Upon receiving the non-standardized data request at the managing entity 410, the managing entity determines the involved network entities in the requested data, such as the LMF for positioning and gNB for CSI feedback use cases of AI/ML models, respectively. The managing entity 410 can get information about serving LMF and serving neighborhood/gNB of the involved UE(s) from other CN entities, such as AMF (Access & Mobility Management Function).

According to another embodiment, the managing entity may select related network entities, such as the gNB, based on the metadata field of the request, such as depending on area information, vendor information, etc. For example, if the request relates to data collection from certain cell/area, the managing entity can then select the gNBs or LMF that are serving the requested area. Further, the managing entity may accept/reject the non-standardized data collection request coming from the external server before forwarding it to the other involved entities.

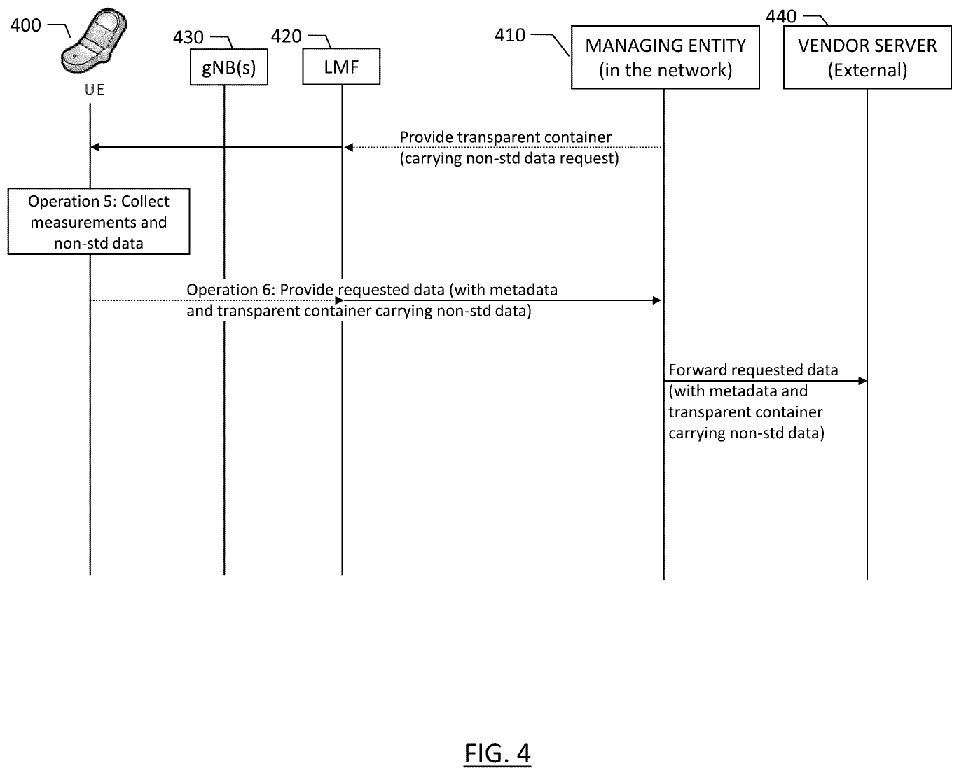

If the request is compliant with the non-standardized data collection policy, the managing entity 410 may, as shown in Operation 3, send the request to the LMF 420. Depending on the policy, the managing entity 410 informs the involved entities about the request. The metadata of the request as well as optional PHY signaling requirements can be forwarded to the determined network entities, such as the LMF 420 and gNB 430, and the transparent container can be forwarded to the UE 400, such as shown at the top of FIG. 4.

FIG. 3 further illustrates Operation 4, an optional process of setting up required physical layer signaling. Involved entities may configure required PHY signaling depending on the requested information. The LMF ma configure gNBs/TRPs to transmit DL PRS with certain characteristics (e.g., bandwidth, periodicity) so as to enable the UE 400 to collect the requested, non-standardized data. In an example embodiment, the involved network entities may accept or reject the request coming from the managing entity (e.g., for PHY signaling), such as based on resource availability. In case the involved network entities configure PHY signaling differently than the one indicated in the request, such as due to resource constrains, the difference may be indicated to the managing entity, which could inform the external server when providing a response (e.g., as shown in Operation 6 of FIG. 4). As an example, if the server requires DL PRS transmission with 200 MHz, but the LMF configures only 100 MHz, the resource constraints cannot accommodate the requested PHY signaling.

The signal diagram of FIG. 3 is continued in FIG. 4, which illustrates Operation 5. Operation 5 depicts the UE 400, upon receiving the transparent container for the non-standardized data request and any associated configurations for required PHY signaling, conducts data collection. The data collection can include measurements if the requested data is not already available at the UE. In some embodiments, the request may be for real-time data, current-session data, historical-session data, a certain period of sessions, or the like. The request to the UE for data collection can be to a specific UE. However, the request may be non-UE specific, such as if the request is broadly applicable to UEs within a certain geographic area, UEs meeting specific criteria, or the like. The vendor server 440 can put rules around which UEs receive the request. These rules can be found in the metadata and the policy, for example,

At Operation 6 of FIG. 4, the UE provides a response to the data request with a container (e.g., the transparent container) that may not be visible to the network, but is visible to the external server 440. The container contains the actual collected non-standardized da a, as well as mandatory metadata fields complying with the non-standardized data collection policy. The metadata field may contain information as in the request for the data collection, such as describing the data content with standardized fields, or simply it may consist of an identification/session information of the request. The requested data, including the metadata and the transparent container including the non-standardized data, is forwarded from the managing entity 410 to the vendor server 440.

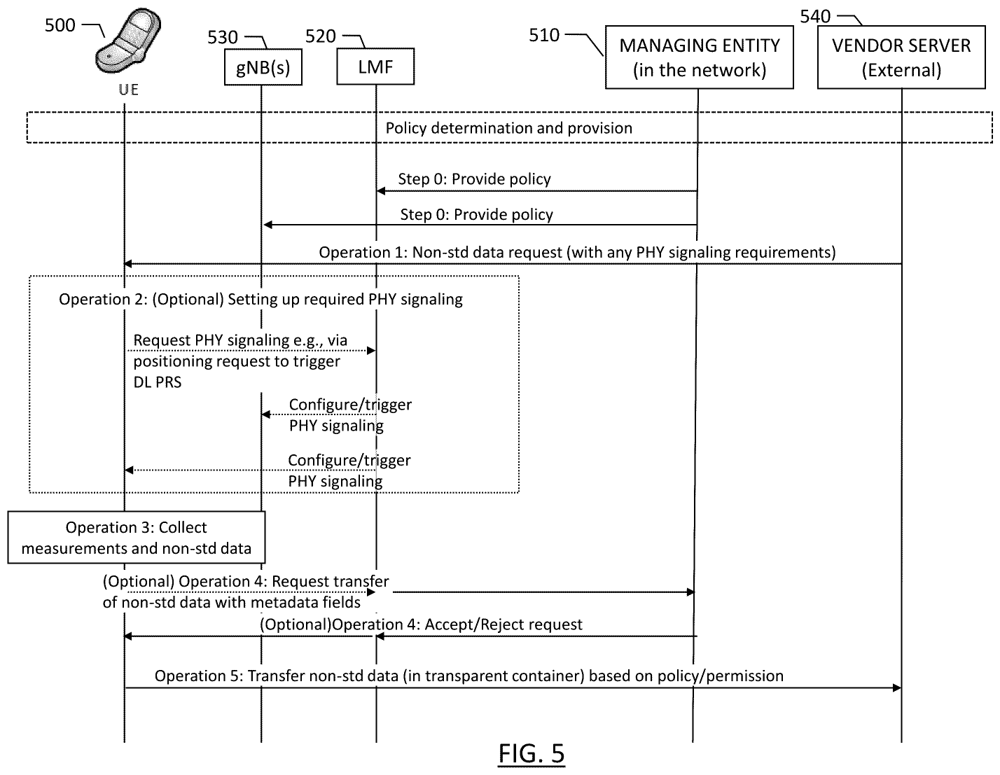

FIG. 5 illustrates another embodiment of signal flow for non-standardized data collection. In the embodiments described with respect to FIGS. 3 and 4, prior to (or after) Operation 1, the managing entity 510 may determine and share the policy for the non-standardized data collection with the vendor server 540 and/or the UE 500. Further, the managing entity 510 may optionally share the policy internally with network entities, such as the LMF 520 and/or gNB(s) 530. These are shown at Operation 0 of FIG. 5.

The external vendor server 540 of the embodiment of FIG. 5 sends the non-standardized data collection request directly to the involved UE(s) 500 in a manner transparent to the network and managing entity 510. The request may indicate any optional PHY signaling requirements. The UE 500, in Operation 2, can request necessary configuration from the involved network entities, such as the LMF 520 for positioning-related data collection.

As found in the embodiment of FIGS. 3 and 4, the UE collects standardized data and/or non-standardized data including any measurement data in Operation 3. Optionally, in Operation 4, the UE 500 then requests from the managing entity 510 permission to transfer the collected non-standardized data to the external vendor server 540 by indicating the associated metadata fields with the collected data. The UE 500 may send the request first to the involved network entities, such as the LMF 520 via LPP in the case of positioning-related data, or to gNB 530 via RRC in the case of CSI-related data. These entities may accept/reject the request based on the data collection policy that may be provided by the managing entity to these entities in Operation 0. Operation 4 is optional in some embodiments. Namely, the framework may trust the UE 500 and vendor server 540 upon provision of the policy in Operation 0, and may not require further request for each data transfer individually, which could be indicated as part of the policy and can be acknowledged (or not) by the UE 500 and/or vendor server 540. Based on the permission, the UE 500 transfers non-standardized data to the external server in a transparent manner to the network (e.g., managing entity 510) such as using a transparent container.

An embodiment described herein provides a clear improvement to the functioning of a computer itself. Specifically, an example embodiment enables an apparatus, such as a third party embodied by a vendor server, to identify and collect non-standardized data from UE devices. UE devices are rich sources of data; however, much of the data collected may be in non-standardized form that is unique to a device (e.g., manufacturer), a software, an application, or a sensor suite of the device. An example embodiment provided herein abides by a policy established at a managing entity of a network to solicit and collect non-standardized data in a manner that can process the non-standardized data to increase a volume of data available to a third party. This data, according to an example embodiment, is used to build and train AI/ML models. AI/ML models benefit from greater volumes of training data, such that the ability to use non-standardized data increases an available volume of training data substantially. Thus, an example embodiment described herein improves the building and training of AI/ML models, which improves the functioning of such model and the computer on which they are used to generate accurate and useful output.

An embodiment described herein addresses a network-centric challenge of harvesting data over wireless communication channels to build and train AI/ML models. A challenge addressed by embodiments is to render previously unavailable, non-standardized data accessible to a vendor server by virtue of a non-standardized data request policy that permits access to non-standardized data, while masking the collected data from a managing entity of a network. This enables a vendor or external server to, in accordance with the non-standardized data request policy, request and obtain non-standardized data in a manner not previously available.

Notwithstanding the above, an embodiment described herein is implemented in a practical application of supporting an AI/ML model creation and training using a volume of data that was previously unavailable to a vendor or external server. This improves the speed of building an accurate and useful AI/ML model as the model does not need to rely upon standardized data, and can request non-standardized data that is specifically requested to fulfill a need of the AI/ML model in a way not previously possible.

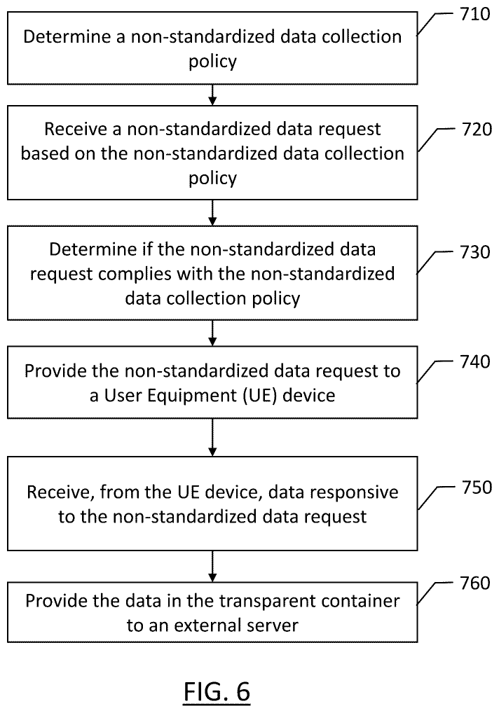

FIG. 6 illustrates a flowchart of an example embodiment of a method for collecting non-standardized data via a network that can be used for training Artificial Intelligence and Machine Learning models. A non-standardized data collection policy is determined at 710. This policy may be determined, for example, by a managing entity in a network, which may be embodied by apparatus 300 of FIG. 2 using means, such as the processor 302. A non-standardized data request may be received based on the non-standardized data collection policy, such as via means, e.g., the network interface 306 of the apparatus and/or at the processor 302 as shown at 720. It is then determined at 730 if the data request is compliant with the non-standardized data collection policy, such as by means, e.g., processor 302 of the apparatus 300. The non-standardized data request is provided, at 740, to the UE device, such as by means, e.g., the network interface 306 instructed by processor 302 of apparatus 300. Data in response to the standardized data request is received at 750 from the UE device, such as in a transparent container. This may be received, for example, by means, such as the network interface 306 and/or the processor 302. A transparent container renders the data transparent, i.e., not visible/available to the network as the data is transmitted. The data is then provided to the external server at 760 such as in a transparent container, which may be performed by means, such as the network interface 306 and/or the processor 302.

FIG. 6 illustrates a flowchart depicting operations according to an example embodiment of the present disclosure. It will be understood that each block of the flowchart and combination of blocks in the flowchart may be implemented by various means, such as hardware, firmware, processor, circuitry, and/or other communication devices associated with execution of software including one or more computer program instructions. For example, one or more of the procedures or operations described above may be embodied by computer program instructions. In this regard, the computer program instructions which embody the procedures or operations described above may be stored by a memory 304 of an apparatus (e.g., apparatus 300, UE 110) employing an embodiment of the present invention and executed by a processor 302. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising:
at least one processor; and
at least one memory including computer program code,
the at least one memory and the computer program code configured to, with the at least one processor, cause the apparatus at least to:
determine a non-standardized data collection policy;
receive a non-standardized data request based on the non-standardized data collection policy;
determine if the non-standardized data request is compliant with the non-standardized data collection policy;
provide the non-standardized data request to a User Equipment (UE) device;
receive, from the UE device, data in response to the non-standardized data request; and
provide the data in a transparent container to an external server.

2. The apparatus of claim 1, wherein the non-standardized data request based on the non-standardized data collection policy is received from the external server.

3. The apparatus of claim 1, wherein the data received from the UE device is received in a transparent container, wherein the data is not decodable by the apparatus.

4. The apparatus of claim 1, wherein the apparatus is further caused to provide the non-standardized data collection policy to the external server.

5. The apparatus of claim 1, wherein the non-standardized data collection policy comprises an indication of data content that is allowed to be transferred from a UE device to the external server.

6. The apparatus of claim 5, wherein data content that is allowed to be transferred is based on one or more of: a type of data, configuration information, a Radio Access Network (RAN) area, a network coverage area, a g Node B (gNB) service area, a Location Management Function (LMF) service area, and a geographical area of data collection.

8. The apparatus of claim 1, wherein the non-standardized data request to the UE device is provided in a transparent container.

9. The apparatus of claim 1, wherein the data comprises position-related data, and wherein the external server employs the position-related data for Artificial Intelligence/Machine Learning model training.

10. The apparatus of claim 1, wherein the non-standardized data collection policy comprises an indication of a protocol in which the non-standardized data request should be signaled and a protocol required to carry the data collected in response to the non-standardized data request.

11. The apparatus of claim 1, wherein the apparatus is further caused to:
provide a request to at least one of a Location Management Function (LMF) or g Node B (gNB) to set up required signaling for the non-standardized data request.

12. The apparatus of claim 1, wherein the data in response to the non-standardized data request comprises non-standardized data transmitted via a standardized data protocol.

13. An apparatus comprising:
at least one processor; and
at least one memory including computer program code,
the at least one memory and the computer program code configured to, with the at least one processor, cause the apparatus at least to:
receive a non-standardized data request with a non-standardized data collection policy;
collect measurements and non-standardized data according to the non-standardized data collection policy; and
transfer the non-standardized data in a transparent container together with metadata according to the non-standardized data collection policy.

14. The apparatus of claim 13, wherein the apparatus is further caused to request physical layer signaling requirements, wherein the physical layer signaling requirements comprise standardized configuration information of signals associated with the non-standardized data request.

15. The apparatus of claim 14, wherein the physical layer signaling requirements comprise one or more of downlink positioning reference signal (DL PRS) bandwidth, number of transmission and reception points (TRPs), or Quality of Service (QoS).

16. The apparatus of claim 13, wherein the apparatus is further caused to request approval to transfer the non-standardized data with metadata fields prior to transmitting the non-standardized data in the transparent container together with the metadata.

17. A method comprising:
receiving a non-standardized data request with a non-standardized data collection policy;
collecting measurements and non-standardized data according to the non-standardized data collection policy; and
transferring non-standardized data in a transparent container together with metadata according to the non-standardized data collection policy.

18. The method of claim 17, further comprising requesting physical layer signaling requirements, wherein the physical layer signaling requirements comprise standardized configuration information of signals associated with the non-standardized data request.

19. The method of claim 18, wherein the physical layer signaling requirements comprise one or more of downlink positioning reference signal (DL PRS) bandwidth, number of transmission and reception points (TRPs), or Quality of Service (QoS).

20. The method of claim 17, further comprising requesting approval to transfer the non-standardized data with metadata fields prior to transmitting the non-standardized data in the transparent container together with the metadata.
